(19) United States
(12) Patent Application Publication
(10) Pub. No.: US 2010/0316974 A1
(43) Pub. Date: Dec. 16, 2010

(54) METHOD OF MAKING A SURGICAL TEMPLATE USED FOR A COMPUTER-GUIDED DENTAL IMPLANT SURGERY

(75) Inventors: Hong-Tzong Yau, Chiayi County (TW); Chuan-Chu Kuo, Chiayi County (TW); Jiun-Ren Chen, Yunlin County (TW); Chun-Chuan Yang, Taichung County (TW); Chien-An Chen, Kaohsiung County (TW); Ying-Li Chen, Kaohsiung City (TW)

Correspondence Address: SCHWABE, WILLIAMSON & WYATT, P.C., 1420 FIFTH, SUITE 3400, SEATTLE, WA, 98101-4010, US

(73) Assignee: Pou Yu Biotechnology Co., Ltd., Changhua Hsien (TW)

(21) Appl. No.: 12/483,132

(22) Filed: Jun. 11, 2009

(51) Int. Cl. A61C 8/00

(52) U.S. Cl. 433/215

(57) ABSTRACT

A method of making a surgical template comprises: producing a 3-D geometrical image by a CT scanning performed on a patient's jaw and establishing corresponding implant planning data to obtain a 3-D first digital image, making a positive plaster model of the patient's jaw, scanning the plaster model to obtain a 3-D second digital image, overlapping the second digital image on the first digital image to obtain a computer representation of the plaster model and at least one implant to be mounted according to the implant planning data, drilling the plaster model to form at least one pinhole according to the implant planning data, inserting a pin into the pinhole, producing a negative template body from an assembly of the plaster model and the pin with a thermoplastic dental material so that the negative template body has at least one implant guide hole and constitutes the surgical template.

### BACKGROUND OF THE INVENTION

1. Field of the Invention

This invention relates to a dental surgical template, and more particularly to a method of making a surgical template used for a computer-guided dental implant surgery.

2. Description of the Related Art

A conventional method of making a surgical template used for a computer-guided dental implant surgery disclosed in Taiwanese Patent No. 093121438 is shown in FIGS. 1 and 2. In step 101, silicone is applied within a casing 14, and is pressed against a patient's jaw. After the silicone is cured, it forms a negative template body 11.

In step 102, in an imaging process, a three-dimensional geometrical image of the patient's jaw is obtained by computerized tomography (CT) technique. Subsequently, the three-dimensional geometrical image is provided to a computer for analysis to thereby further obtain implant planning data, such as depth, length, position, inclination angle, etc. In step 103, a movable support is moved to adjust the position and inclination angle of the negative template body 11 such that the negative plate body 11 can be drilled to form implant guide holes 12 according to the data obtained in the step 102.

In step 104, a plurality of sleeves 13 are inserted respectively into the implant guide holes 12 in the negative template body 11 to thereby form the surgical template for guiding a drill through the negative template body 11 and into the patient's jaw during dental implant surgery.

In the conventional method, to apply the implant planning data to the negative template body 11 for performing the hole-drilling step and the sleeve-inserting step, it is necessary to relate the negative template body 11 with the computer-operated virtual three-dimensional geometrical image of the patient's jaw. However, in such correlation, since only a small amount of overlapping portions occur between the negative template body 11 and the virtual three-dimensional geometrical image, it is difficult to correct the distortions in CT scan of the patient's jaw. As a result, several repeated corrections are required to obtain a comparatively accurate surgical template 11, which reduces the efficiency of the conventional method.

### SUMMARY OF THE INVENTION

The object of this invention is to provide a method of making a surgical template used for a computer-guided dental implant surgery, which can apply accurately, precisely, and efficiently virtual implant planning data to the surgical template.

According to this invention, a method for making a surgical template used for a computer-guided dental implant surgery comprises the steps of:

(a) producing a three-dimensional geometrical image by a CT scanning performed on a patient's jaw and establishing corresponding implant planning data to obtain a three-dimensional first digital image including the geometrical image and the implant planning data;

(b) making a negative model by direct impression modeling of the patient's jaw, and then a positive plaster model from the negative model;

(c) fixing the plaster model on a fixture;

(d) scanning the plaster model and the fixture to obtain a three-dimensional second digital image;

(e) overlapping the second digital image on the first digital image during image processing to obtain a computer representation of an assembly of the plaster model and the fixture having the implant planning data;

(f) setting the assembly of the plaster model and the fixture at a predetermined position relative to a CNC machine by a machining software, and subsequently moving the assembly of the plaster model and the fixture to the predetermined position;

(g) drilling the plaster model to form at least one pinhole therein according to the implant planning data;

(h) inserting a pin into the pinhole in the plaster model such that an outer end of the pin is disposed outwardly of the plaster model; and

(i) producing a negative template body from an assembly of the plaster model and the pin with a thermoplastic dental material so that the negative template body has at least one implant guide hole formed therethrough and corresponding to the pin.

The surgical plate includes the negative template body and a sleeve inserted into the implant guide hole in the negative template body.

In the step (g), since a substantial amount of overlapping occurs between the first and second digital images due to the fact the plaster model is a positive model, the implant planning data can be applied accurately, precisely, and efficiently to the plaster model, thereby allowing the implant guide hole to be formed at an ideal position. As a consequence, the surgical template made by the method of this invention can be excellent in the implant-guiding effect.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a flow chart of a conventional method of making a surgical template for dental implant disclosed in Taiwanese Patent No. 093121438;

FIG. 2 is a partly sectional view illustrating how a negative template body is formed in the step 101 of the conventional method;

FIG. 3 is a flow chart of the first preferred embodiment of a method of making a surgical template used for dental implant surgery according to this invention;

FIG. 4 is a flow chart of the second preferred embodiment of a method of making a surgical template used for dental implant surgery according to this invention;

FIG. 5 is a flow chart of the third preferred embodiment of a method of making a surgical template used for dental implant surgery according to this invention;

FIG. 6 is a flow chart of the fourth preferred embodiment of a method of making a surgical template used for dental implant surgery according to this invention;

FIG. 7 is a positive plaster model made in the method of this invention;

FIG. 8 is a schematic perspective view illustrating how the plaster model is held on a fixture in the method of this invention;

FIG. 9 is a schematic perspective view illustrating how pinholes are formed in the plaster model;

FIG. 10 is a schematic perspective view of a plurality of pins inserted respectively into the pinholes in the plaster model;

FIG. 11 is a schematic perspective view illustrating how a first coating material is coated on an assembly of the plaster model and the pins;

FIG. 12 is a schematic perspective view illustrating how a second coating material is coated on the first coating material;

FIG. 13 is a schematic perspective view illustrating a surgical template made by the method of this invention;

FIG. 14 is a schematic side view of one of the pins;

FIG. 15 is a schematic side view of a sleeve of the surgical template;

FIG. 16 is an assembled side view of one of the pins and the sleeve;

FIG. 17 is a three-dimensional digital image including the images of a patient's jaw and implants to be mounted thereon according to implant planning data;

FIG. 18 is a three-dimensional digital image of the fixture;

FIG. 19 is a three-dimensional digital image of the plaster model;

FIG. 20 is a three-dimensional digital image of the implants; and

FIG. 21 is a computer representation of an assembly of the plaster model and a fixture with the implants.

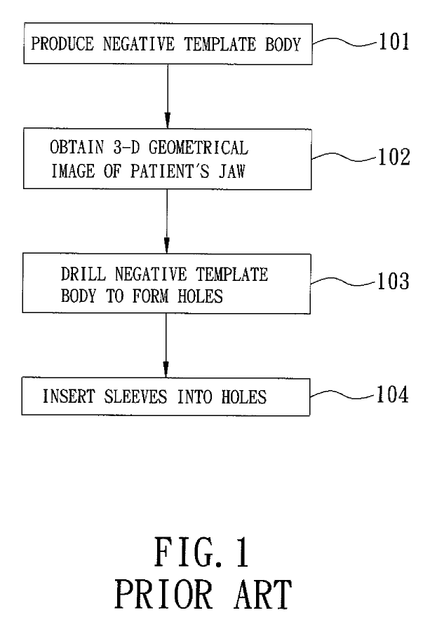

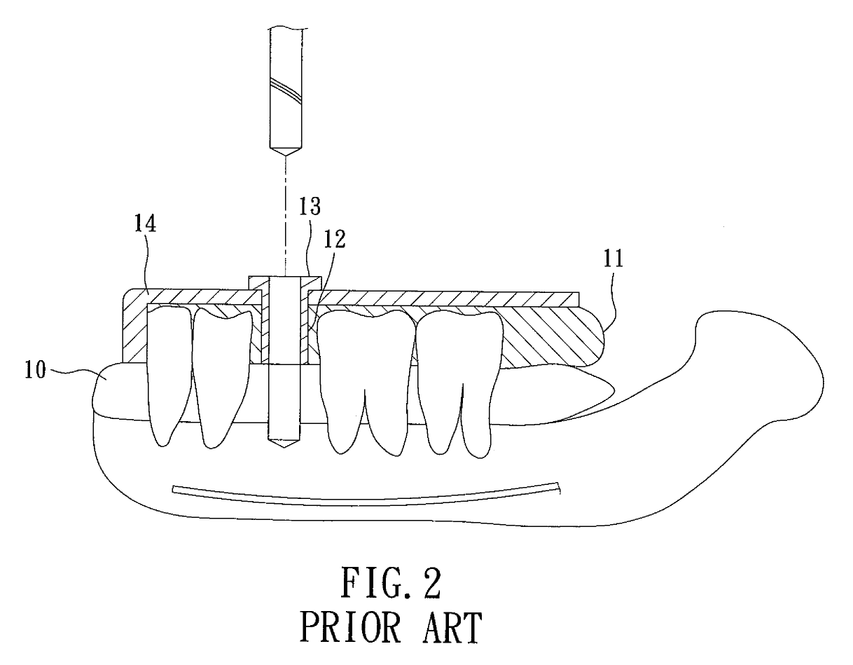

### DETAILED DESCRIPTION OF THE PREFERRED EMBODIMENTS

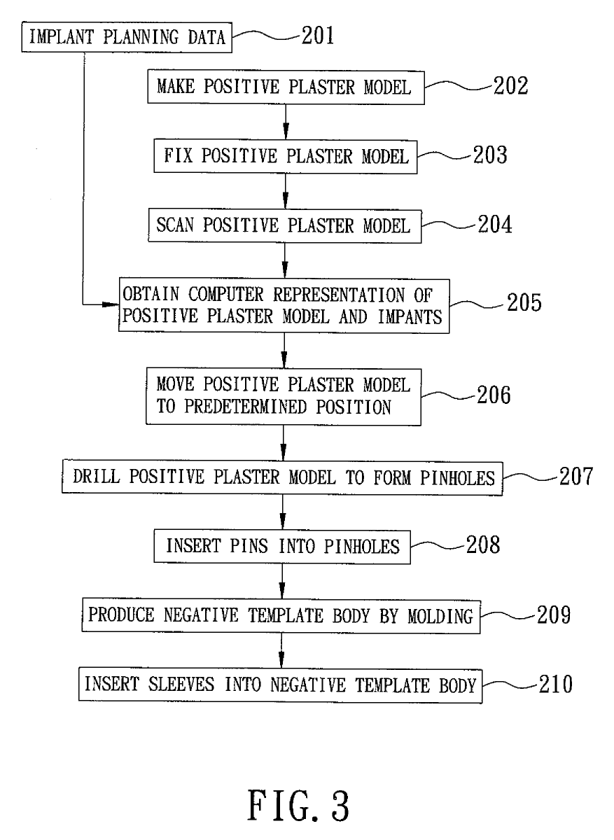

FIG. 3 is a flow chart illustrating the first preferred embodiment of a method of making a surgical template used for dental implant surgery according to this invention.

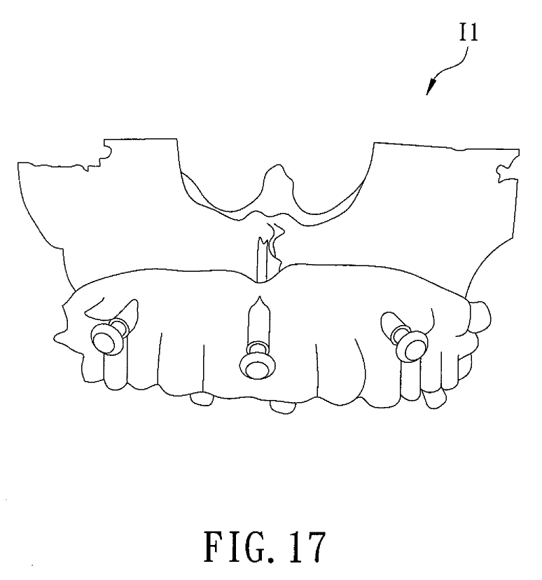

In step 201, a three-dimensional geometrical image is produced by a CT (computerized tomography) scanning performed on a patient's jaw. The geometrical image is provided to a computer for analysis to thereby establish implant planning data, such as depth, length, position, inclination angle, etc. Hence, a first three-dimensional digital image (I1) (see FIG. 17) including the geometrical image and the images of implants to be mounted on the patient's jaw according to the implant planning data is obtained.

In step 202, a negative silicone model (not shown) is made by direct impression modeling of the patient's jaw. Then, a positive plaster model 2 (see FIG. 7) is made from the negative silicone model.

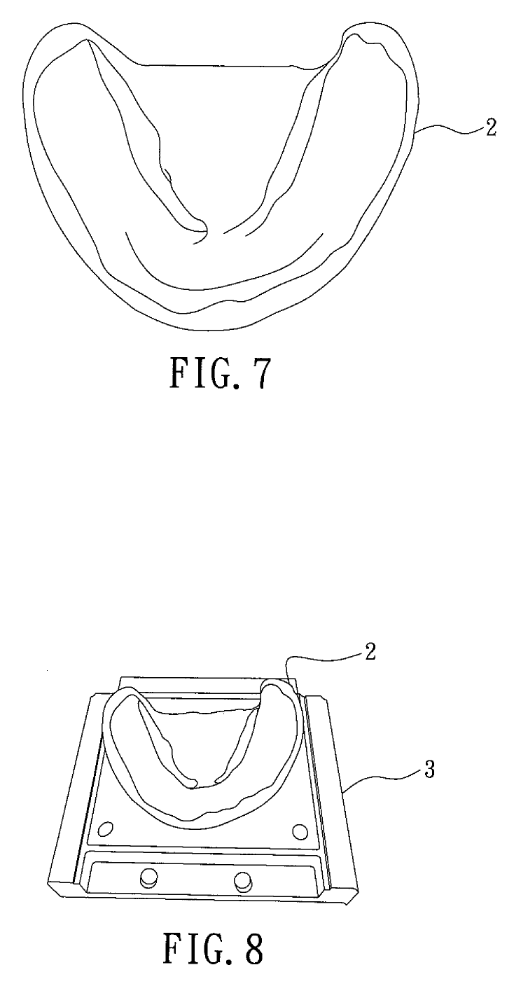

Referring to FIG. 8, in step 203, the plaster model 2 is fixed on a fixture 3. In this embodiment, the plaster model 2 is connected threadedly to the fixture 3.

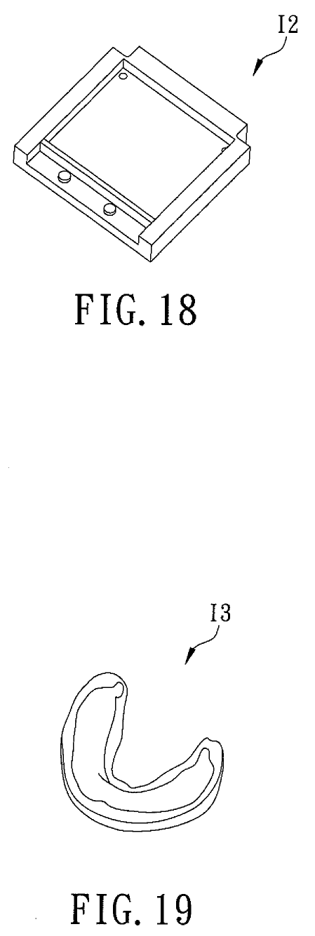

In step 204, the plaster model 2 and the fixture 3 are scanned to obtain a three-dimensional second digital image including the three-dimensional digital images (I2, I3) of the fixture 3 and the plaster model 2, which are shown in FIGS. 18, 19, respectively.

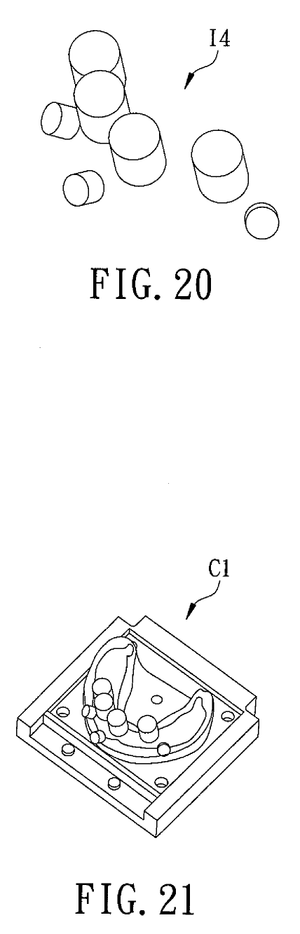

In step 205, the second digital image is overlapped on the first digital image for image processing. Hence, a computer representation (see FIG. 21) of an assembly of the plaster model 2 and the fixture 3 is obtained, and has the images (I4) (see FIG. 20) of the implants.

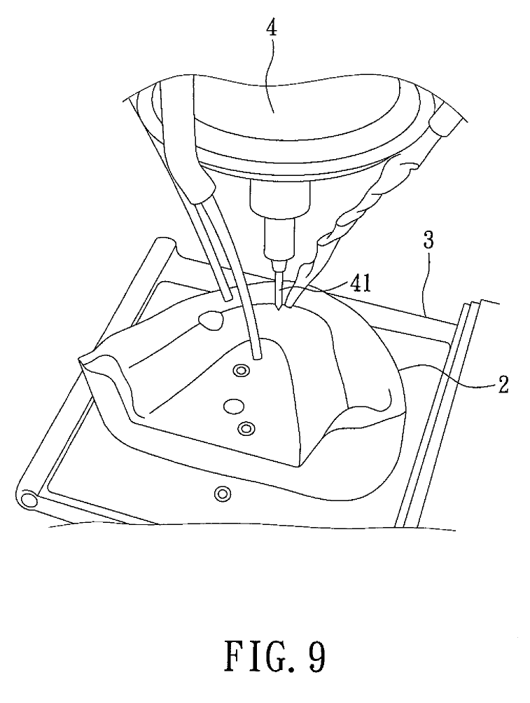

In step 206, referring to FIG. 9, the assembly of the plaster model 2 and the fixture 3 is set at a predetermined position relative to a CNC machine 4 by a machining software, and the moving path of a drill 41 of the CNC machine 4 is planned according to the implant planning data. Subsequently, the assembly of the plaster model 2 and the fixture 3 is moved to the predetermined position. In this embodiment, the CNC machine is a five-axis machine tool.

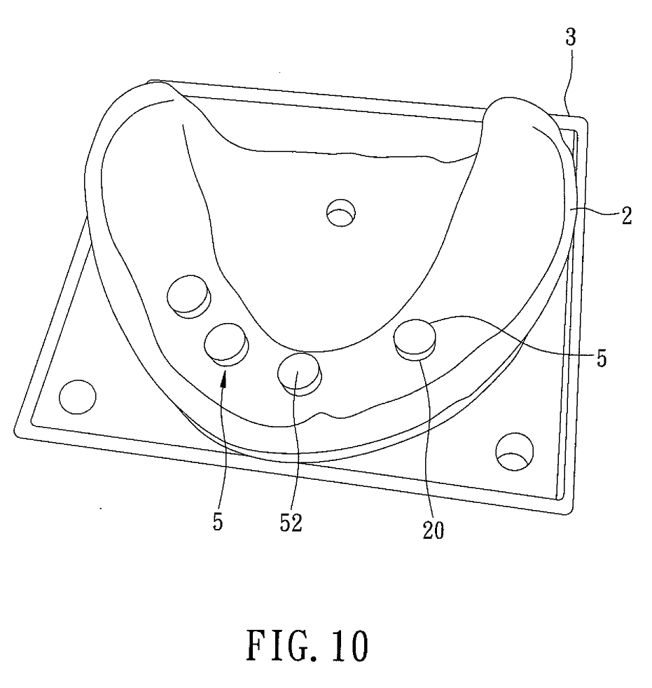

In step 207, after the assembly of the plaster model 2 and the fixture 3 is moved to the predetermined position, the drill 41 of the CNC machine 4 is moved along the planned moving path to drill the plaster model 2 according to the implant planning data to form a plurality of pinholes 20 (see FIG. 10).

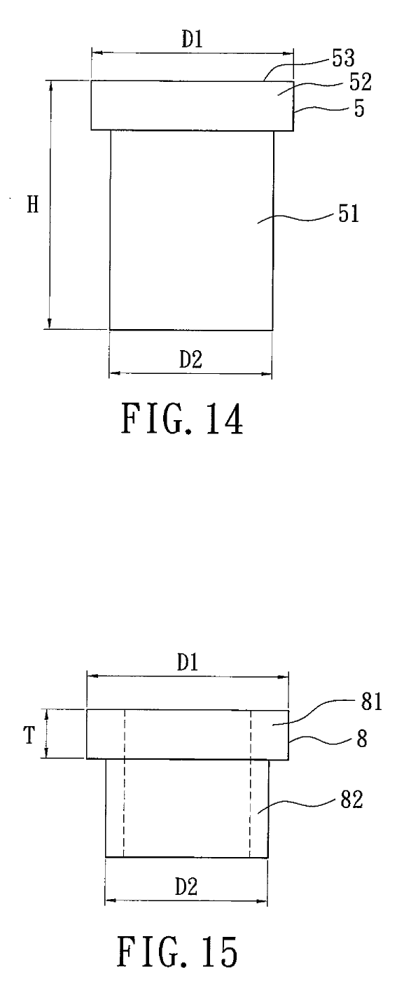

In step 208, referring to FIGS. 10 and 14, a plurality of pins 5 are inserted respectively into the pinholes 20 in the plaster model 2. Each of the pins 5 has a pin body 51 disposed within the corresponding pinhole 20 in the plaster model 2, and a head 52 disposed outwardly of the plaster model 2 and spaced apart from a portion of an outer surface of the plaster model 2 defining the corresponding pinhole 20 by a predetermined distance.

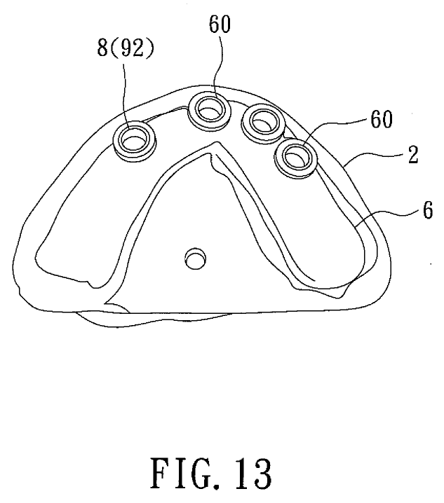

Referring to FIGS. 11 and 13, in the step 209, a negative template body 6 is produced from an assembly of the plaster model 2 and the pins 5 with a thermoplastic dental material by a molding process, and has a plurality of implant guide holes 60 formed therethrough and corresponding to the pins 5, respectively.

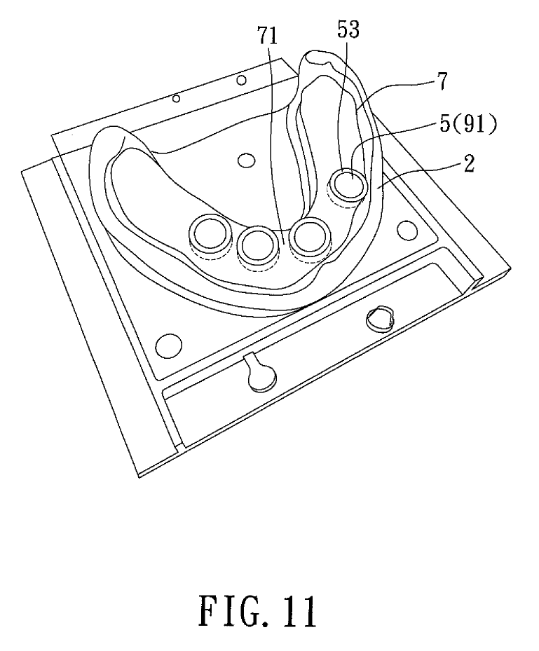

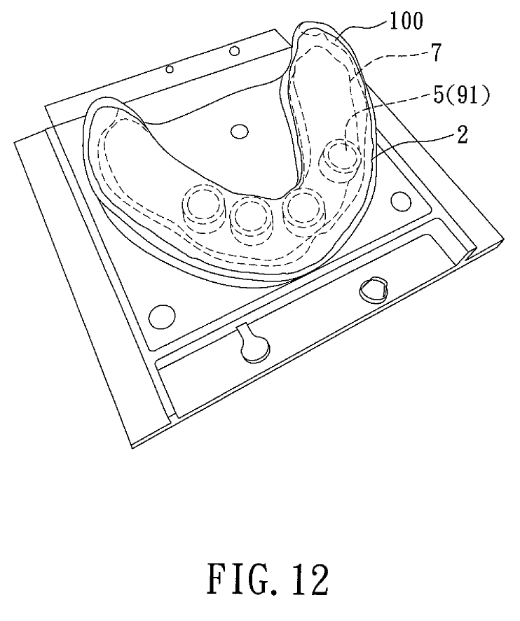

The molding process includes the following steps:
(1) Referring to FIG. 11, a thermoplastic first coating material 7 is coated on the assembly of the plaster model 2 and the pins 5. The first coating material 7 has an outer surface 71 that is aligned with end surfaces of the pins 5. In this embodiment, the first coating material 7 is wax.
(2) Referring to FIG. 12, a second coating material 100 is coated on the first coating material 7. The second coating material 100 has a melting point higher than that of the first coating material 7. In this embodiment, the second coating material 100 is silicone.
(3) The first and second coating materials 7, 100 are heated to a temperature between the melting points of the first and second coating materials 7, 100 so as to melt only the first melting material 7, thereby forming a mold cavity having the same shape as the negative template body 6. As such, the plaster model 2, the pin 5, and the second coating material 100 constitute cooperatively a mold.
(4) The dental material is heated and poured into the mold cavity.
(5) When cured, the dental material forms the negative template body 6.
(6) The second coating material 100, the pins 5, and the plaster model 2 are removed from the negative template body 6.
(7) The negative template body 6 is ground and polished.

In step 210, a plurality of sleeves 8 are inserted respectively into the implant guide holes 60 in the negative template body 6 to form the surgical template. Preferably, the sleeves 8 are made of metal. With further reference to FIGS. 14 and 15, each of the sleeves 8 has a sleeve body 82 disposed within the corresponding implant guide holes 60 in the negative template body 6, and a flange 81 extending radially and outwardly from an end of the sleeve body 82, abutting against an outer surface of the negative template body 6, and having an axial thickness (T) that is equal to the predetermined distance between the head 52 of each of the pins 5 and the portion of the outer surface of the plaster model 2 defining the corresponding pinhole 20 (see FIG. 10). The outer diameter of each of the heads 52 of the pins 5 and the flanges 81 of the sleeves 8 is D1. The outer diameter of each of the pin bodies 51 of the pins 5 and the sleeve bodies 82 of the sleeves 8 is D2. Each of the pins 4 has an axial length (H) that is determined according to the depth of the corresponding implant planned in the implant planning data.

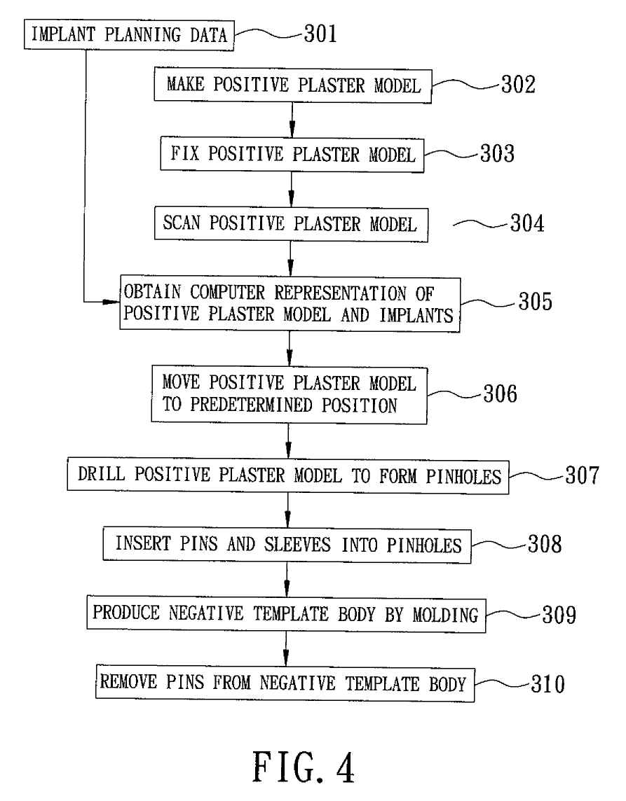

FIG. 4 is a flow chart illustrating the second preferred embodiment of a method of making a surgical template used for dental implant surgery according to this invention, which is similar to the first preferred embodiment and which includes steps 301 to 310. The steps 301 to 307 are the same as the steps 201 to 207 of the first preferred embodiment, respectively. The step 309 is the same as the step 209 of the first preferred embodiment.

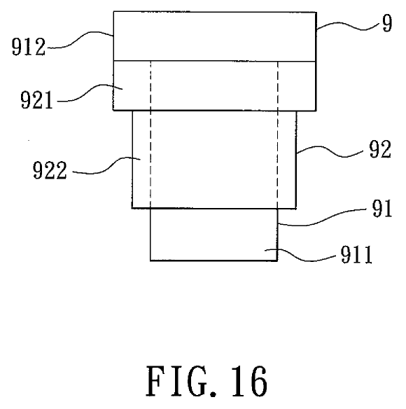

In the step 308, with further reference to FIG. 16, the pin bodies 911 of the pins 91 are inserted respectively into the pinholes 20 in the plaster model 2 by first inserting the pins 91 through the sleeve bodies 922 of the sleeves 92, respectively, to form a plurality of pin assemblies 9, and then inserting the pin assemblies 9 into the pinholes 20, respectively. Hence, two opposite axial end surfaces of the flange 921 of each of the sleeves 92 abut respectively against the head 912 of the corresponding pin 91 and the outer surface of the plaster model 2, and the portion of the pin body 911 of each of the pins 91 extending outwardly of the corresponding sleeve 92 is disposed within the corresponding pinhole 20.

In the step 310, the pins 91 and the plaster model 2 are removed from an assembly of the negative template body 6 and the sleeves 92.

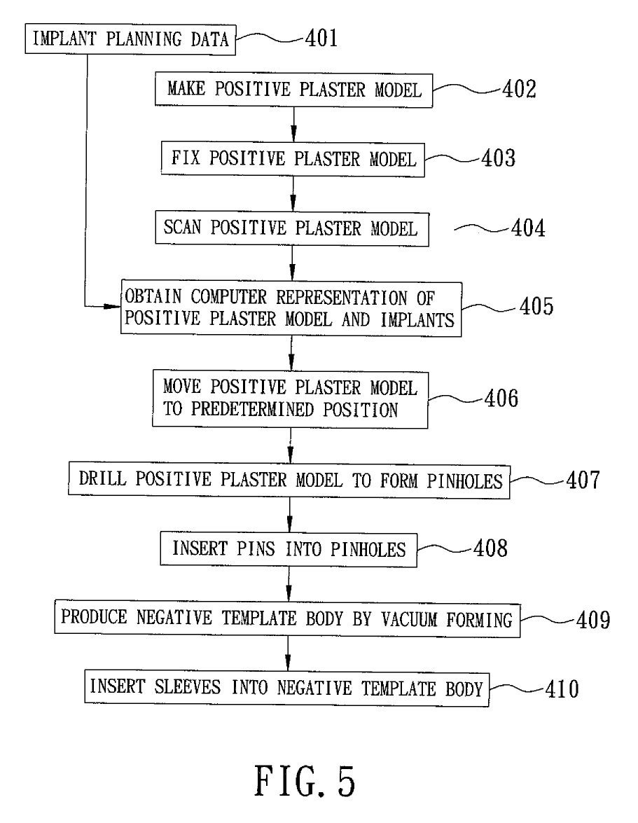

FIG. 5 is a flow chart illustrating the third preferred embodiment of a method of making a surgical template used for dental implant surgery according to this invention, which is similar to the first preferred embodiment and which includes steps 401 to 410. The steps 401 to 408 are the same as the steps 201 to 208 of the first preferred embodiment, respectively. The step 410 is the same as the step 210 of the first preferred embodiment.

In the step 409, the negative template body 6 is produced by a vacuum forming process.

The vacuum forming process includes the following steps:
(1) A plastic sheet (not shown) is prepared.
(2) The plastic sheet is heated and softened.
(3) The softened plastic sheet is placed on the plaster model 2 and the pins 5.
(4) A vacuum is applied to the softened plastic sheet to allow the softened plastic sheet to deform such that a side surface of the softened plastic sheet is complementary in structure to an assembly of the plaster model 2 and the pins 5.
(5) The deformed plastic sheet is hardened.
(6) The hardened plastic sheet is trimmed.
(7) The plaster model 2 and the pins 5 are removed from the trimmed plastic sheet.
(8) The trimmed plastic sheet is ground and polished.

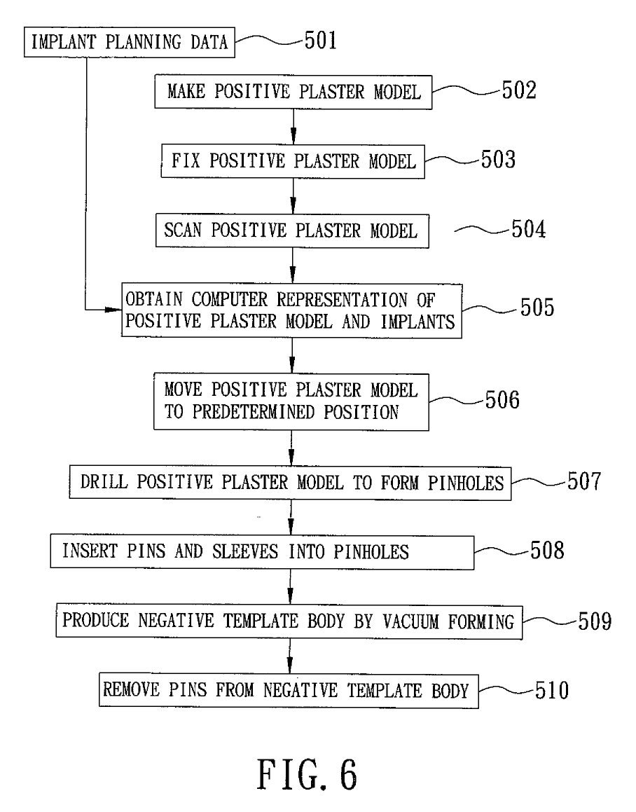

FIG. 6 is a flow chart illustrating the fourth preferred embodiment of a method of making a surgical template used for dental implant surgery according to this invention, which is similar to the second preferred embodiment and which includes steps 501 to 510. The steps 501 to 508 are the same as the steps 301 to 308 of the second preferred embodiment, respectively. The step 509 is the same as the step 409 of the third preferred embodiment. The step 510 is the same as the step 310 of the second preferred embodiment.

In view of the above, the method of this invention has the following advantages:
1. Since a substantial amount of overlapping occurs between the first and second digital images due to the fact the plaster model 2 is a positive model, the implant planning data can be applied accurately, precisely, and efficiently to the plaster model 2, thereby allowing the implant guide holes 60 to be formed at ideal positions. That is, time required for correcting the distortions in CT scan of the patient's jaw can be reduced significantly, thereby promoting the efficiency of the method of this invention and reducing the manufacturing costs of the surgical template.
2. The sizes of the pins 5, 91 and the sleeves 8, 92 can be changed according to selected depths and lengths of the implants, thereby improving the implant-guiding effect and application flexibility of the surgical template.

With this invention thus explained, it is apparent that numerous modifications and variations can be made without departing from the scope and spirit of this invention. It is therefore intended that this invention be limited only as indicated by the appended claims.

We claim:

1. A method of making a surgical template used for a computer-guided dental implant surgery, comprising the steps of:
(a) producing a three-dimensional geometrical image by a CT scanning performed on a patient's jaw and establishing corresponding implant planning data to obtain a three-dimensional first digital image including the geometrical image and the image of at least one implant to be mounted on the patient's jaw according to the implant planning data;
(b) making a negative model by direct impression modeling of the patient's jaw, and then a positive plaster model from the negative model;
(c) fixing the plaster model on a fixture;
(d) scanning the plaster model and the fixture to obtain a three-dimensional second digital image;
(e) overlapping the second digital image on the first digital image during image processing to obtain a computer representation of an assembly of the plaster model and the fixture having the implant planning data;
(f) setting the assembly of the plaster model and the fixture at a predetermined position relative to a CNC machine by a machining software, and subsequently moving the assembly of the plaster model and the fixture to the predetermined position;
(g) drilling the plaster model to form at least one pinhole therein according to the implant planning data;
(h) inserting a pin into the pinhole in the plaster model such that an outer end of the pin is disposed outwardly of the plaster model; and
(i) producing a negative template body from an assembly of the plaster model and the pin with a thermoplastic dental material so that the negative template body has at least one implant guide hole formed therethrough and corresponding to the pin;
whereby, the surgical plate includes the negative template body.

2. The method as claimed in claim 1, wherein, in said step (C), the plaster model is connected threadedly to and thus fixed on the fixture.

3. The method as claimed in claim 1, wherein, in said step (f), the CNC machine is a five-axis machine tool.

4. The method as claimed in claim 1, wherein, in said step (i), the negative template body is produced by a molding process that includes the substeps of:
(1) coating the assembly of the plaster model and the pin with a thermoplastic first coating material such that an outer surface of the first coating material is aligned with an end surface of the pin;
(2) coating the first coating material with a second coating material having a melting point higher than that of the first coating material;
(3) heating the first and second coating materials to a temperature between the melting points of said first and second coating materials so as to melt the first coating material, thereby forming a mold cavity such that the plaster model, the pin, and the second coating material constitute cooperatively a mold;
(4) heating and pouring the dental material into the mold cavity;
(5) allowing the dental material to cure to thereby form the negative template body; and
(6) removing the second coating material, the pin, and the plaster model from the negative template body.

5. The method as claimed in claim 4, wherein, in said step (i), said molding process further includes a substep (7) of, after said substep (6), grinding and polishing the negative template body.

6. The method as claimed in claim 1, after said step (i) further comprising a step (j) of inserting a sleeve into the implant guide hole in the negative plate body, the sleeve having a sleeve body disposed within the implant guide hole, and a flange extending radially and outwardly from an end of the sleeve body and abutting against an outer surface of the negative template body;
Whereby, the surgical template further includes the sleeve.

7. The method as claimed in claim 6, wherein, in said step (h), after the pin is inserted into the pinhole in the plaster model, a pin body of the pin is disposed within the pinhole in the plaster model, and a head of the pin is disposed outwardly of the plaster model, constitutes the outer end of the pin, and is spaced apart from a portion of an outer surface of the plaster model defining the pinhole by a predetermined distance equal to the axial thickness of the flange of the sleeve.

8. The method as claimed in claim 1, wherein:
in said step (h), the pin is inserted into the pinhole in the plaster model by inserting the pin through a sleeve, and inserting an assembly of the pin and the sleeve into the pinhole such that two opposite axial end surfaces of an outwardly extending flange of the sleeve abut respectively against the head of the pin and an outer surface of the plaster model; and
said method further comprises a step (j) of, after said step (i), removing the pin and the plaster model from an assembly of the negative template body and the sleeve;
whereby the surgical template further includes the sleeve.

9. The method as claimed in claim 8, wherein, in said step (i), said negative template body is produced by a molding process that includes the substeps of:
(1) coating the assembly of the plaster model, the pin, and the sleeve with a thermoplastic first coating material such that an outer surface of the dental material is aligned with the outer end of the pin;
(2) coating the first coating material with a second coating material having a melting point higher than that of the first coating material;
(3) heating the first and second coating materials to a temperature between the melting points of said first and second coating materials so as to melt the first coating material, thereby forming a mold cavity such that the plaster model, the pin, the sleeve, and the second coating material constitute cooperatively a mold;
(4) heating and pouring the dental material into the mold cavity;
(5) allowing the dental material to cure to thereby form the negative template body; and
(6) removing the second coating material, the pin, and the plaster model from an assembly of the negative template body and the sleeve.

10. The method as claimed in claim 9, wherein, in said step (i), said molding process further includes a substep (7) of, after said substep (6), grinding and polishing the negative template body.

11. The method as claimed in claim 1, wherein, in said step (i), the negative template body is produced by a vacuum forming process.

12. The method as claimed in claim 11, wherein, in said step (i), the vacuum forming process includes the substeps of:
(1) preparing a plastic sheet;
(2) heating and softening the plastic sheet;
(3) placing the softened plastic sheet on the plaster model and the pin;
(4) applying a vacuum to the softened plastic sheet to allow the softened plastic sheet to deform so that a side surface of the softened plastic sheet is complementary in structure to an assembly of the plaster model and the pin;
(5) hardening the deformed plastic sheet;
(6) trimming the hardened plastic sheet; and
(7) removing the plaster model and the pin from the trimmed plastic sheet.

13. The method as claimed in claim 12, wherein, in said step (i), the vacuum forming process further includes a step (8) of, after said substep (7), grinding and polishing the trimmed plastic sheet.

14. The method as claimed in claim 11, wherein, in said step (h), after the pin is inserted into the pinhole in the plaster model, a pin body of the pin is disposed within the pinhole in the plaster model, and a head of the pin is disposed outwardly of the plaster model, constitutes the outer end of the pin, and is spaced apart from the outer end of the pinhole by a predetermined distance.

15. The method as claimed in claim 14,further comprising a step (j) of, after said step (i), inserting a sleeve into the implant guide hole in the negative plate body so that a sleeve body of the sleeve is disposed within the implant guide hole, and a flange of the sleeve extends radially and outwardly from an end of the sleeve body and abuts against an outer surface of the negative template body, the flange having an axial thickness equal to the predetermined distance;
Whereby, the surgical template further includes the sleeve.
